(19) United States
(12) Patent Application Publication
(10) Pub. No.: US 2016/0318798 A1
(43) Pub. Date: Nov. 3, 2016

(54) RECOVERY OF VALUE ADDED INDUSTRIAL PRODUCTS FROM FLUE-GAS DESULFURIZATION WASTE WATERS AT POWER PLANTS

(71) Applicant: Headwaters Incorporated, South Jordan, UT (US)

(72) Inventors: Rafic Minkara, Kennesaw, GA (US); Nii Narh Nortey Yeboah, Taylorsville, GA (US)

(21) Appl. No.: 15/135,915

(22) Filed: Apr. 22, 2016

Related U.S. Application Data
(60) Provisional application No. 62/154,237, filed on Apr. 29, 2015.

(51) Int. Cl. C04B 14/28; C04B 28/02; C04B 28/04

(52) U.S. Cl. CPC C04B 14/28; C04B 28/04; C04B 28/021

(57) ABSTRACT

Cementitious mixtures comprising precipitate calcium carbonate (PCC) and hydraulic cement and methods of making same. The PCC may be obtained as a precipitate product from reaction of flue gas desulverization wastewater (FGDW) and sodium carbonate.

### CROSS REFERENCE TO RELATED APPLICATION

This application claims the priority benefit of U.S. Provisional Patent Application Ser. No. 62/154,237 filed Apr. 29, 2015.

### BACKGROUND OF THE INVENTION

Flue gas desulfurization (FGD) is a process used in coal-fired power plants to remove sulfur dioxide (SO₂) from coal combustion flue-gas. In the wet FGD process, the SO₂ is removed by contacting the flue-gas with an aqueous solution or slurry containing either lime (Ca[OH]₂), or limestone (CaCO₃). The soluble calcium cation reacts with the gaseous SO₂ to form calcium sulfite or calcium sulfate (gypsum) solids which are removed from the scrubber slurry by filtration. Along with SO₂, the FGD process also captures other flue gas constituents such as chlorides (in the form of HCl and metal chlorides), selenium, and arsenic. Chlorides concentration in particular can be quite high in FGD slurry and solutions depending on the type of coal being burned.

After filtering the sulfur byproduct solids (calcium sulfite and calcium sulfate) from the FGD slurry, the vast majority of the scrubbed constituents end up in the FGD wastewater (FGDW). Until now, power plants have been able to comply with EPA regulations by disposing of the FGDW by combining it with other (much less concentrated) wastewater streams from different processes within the power plant, then holding it in onsite detention basins, allowing solids to settle, and subsequently releasing the diluted, combined wastewater back into natural wasters. New EPA regulations now require the treatment of individual wastewater streams before they are diluted and released into the environment. These new regulations require Power Plants to either dispose of the FGDW without releasing it into the environment, or to reduce the contaminant concentrations to appropriate levels before the FGDW is combined with other wastewater from the plant. Concentrating the FGDW into a brine and evaporating its residual water would result in a hygroscopic calcium chloride that would adsorb ambient moisture and becomes a difficult to handle slime. The disposal of the concentrated brine or the unstable calcium chloride is very challenging.

### SUMMARY OF THE INVENTION

In one exemplary embodiment of the invention, a cementitious mixture is provided wherein the mixture comprises: a) precipitate calcium carbonate (PCC) and b) a hydraulic cement. The PCC is obtained as precipitate product from reaction of flue gas desulfurization wastewater (FGDW) and sodium carbonate.

In certain exemplary embodiments, the hydraulic cement comprises Portland Cement (PC) clinker. In some embodiments, the hydraulic cement comprises a pozzolanic material with the PCC being present in an amount of 1-35 wt % based on the weight of PCC and hydraulic cement. In certain aspects of the invention, the pozzolanic material may comprise fly ash.

In further aspects of the invention, the cementitious mixture of PCC and hydraulic cement is hydrated via the addition of water thereto. The water c) may be present in an amount of c): 0.15-1.5x, wherein x is the combined weight of PCC and hydraulic cement. In further embodiments, the PCC has a particle size ranging from 1-100 μm, and in other instances, the median particle size of the PCC may be in the range of about 10-20 μm or even within the range of about 10-15 μm.

Other aspects of the invention pertain to a calcium carbonate product that is adapted for use in a cementitious mixture. The calcium carbonate is a reaction product of FGDW and soda ash. The calcium carbonate product may have a particle size of about 1-100 μm and a median particle size of about 10-20 μm.

The calcium carbonate product may be in combination with fly ash wherein the calcium carbonate is present in an amount of 1-99 wt % based on the combined weight of the calcium carbonate product and the fly ash. The fly ash may be present in an amount of 99 wt % -1 wt % based upon the combined weight of the calcium carbonate and fly ash.

In other embodiments of the invention, methods are provided for making cementitious mixtures comprising mixing precipitate calcium carbonate (PCC) and a hydraulic cement to form a mix. The PCC is obtained as a precipitate product from reaction of flue gas desulfurization wastewater (FGDW) and sodium carbonate. The hydraulic cement may, for instance, comprise Portland Cement clinker. Water is added to the mix, and in some instances, fly ash is also added to the mix. In other exemplary embodiments, aggregate is added to the PCC/hydraulic cement mix.

The invention will be further described in the appended drawings and following detailed description. In the drawings:

### BRIEF DESCRIPTION OF THE DRAWINGS

FIG. 1 is a graph showing particle size distribution for unblended CaCO₃ precipitate Portland Cement (PC) and a variety of PCC CaCO₃/PC blends;

FIG. 2a is a graph showing isothermal calorimetry analysis results as a function of various hydrated PCs and blends of hydrated PCC/PC with the x axis showing time after hydration;

FIG. 2b is a graph similar to FIG. 2a but with different x axis times after hydration shown; and

FIG. 2c is a graph similar to FIGS. 2a and 2b but with different x axis times after hydration shown.

### DETAILED DESCRIPTION

In one exemplary embodiment, a process is disclosed whereby value added industrial products can be recovered from FGDW, and make it easier to dispose of or reuse the remaining water. The basic chemical principle of this process is to convert the unstable calcium chloride into a valuable calcium carbonate mineral product. The FGDW, which contains high levels of chlorides (primarily CaCl₂) is reacted with sodium carbonate (in the form of soda ash) to Precipitate Calcium Carbonate (PCC). (See Equ 1. below).

CaCl_{2 aqueous}+Na₂CO_{3 solid}→CaCO_{3 solid}30 2NaCl_{aqueous} Equ 1.

The precipitated CaCO₃ is collected by a filtration process, the liquid filtrate can then be concentrated and dried to produce non-hygroscopic sodium chloride (NaCl). Table 1 shows the chemistry of actual FGDW from a power plant burning Illinois Basin bituminous coal, as well as the soda ash treated and filtered FGDW at the laboratory scale.

TABLE 1
Chemistry of FGDW and Treated FGDW at Laboratory Scale

| | Concentration [mg/L] | |
|---|---|---|
| Chemical | FGDW (CaCl | Treated FGDW |
| Constituent | aqueous) | (NaCl aqueous) |
| Calcium | 39,000 | 6.2 |
| Chloride | 6,000 | 6,200 |
| Magnesium | 3,900 | 39 |
| Sulfate | 1,200 | 910 |
| Bromide | 81 | 62 |
| Sodium | 52 | 26,000 |
| Potassium | 17 | 140 |
| Silicon | 16 | 5.3 |
| Manganese | 1.1 | 0.043 |
| Zinc | 0.93 | 0.035 |
| Selenium | 0.33 | 0.21 |
| Cadmium | 0.083 | ND |
| Phosphorous | 0.047 | 1 |
| Iron | 0.028 | ND |
| Chromium | 0.009 | 0.029 |
| Arsenic | 0.002 | 0.011 |
| Aluminum | ND | ND |
| Copper | ND | ND |
| Lead | ND | 0.026 |
| Mercury | ND | ND |

Note:
ND = non-detect

Chemical compositions of the two solid products (CaCO₃ and NaCl) from this FGD brine treatment process are summarized in Table 2. This process allows for the beneficial use of these two recovered materials and the reuse of treated water.

Table 3 summarizes some of the potential applications for the recovered CaCO₃ and NaCl generated from FGDW in this conversion. Of particular interest is the use of CaCO₃ precipitate (PCC) as a replacement for mined and milled limestone in Portland Limestone Cement.

Conventional Portland Limestone Cement (PLC) is manufactured by co-grinding mined limestone with cement clinker. Typically, in PLC processes from about 6-35% limestone is co-ground with the clinker. Co-grinding these two dissimilar materials has been challenging for the cement industry thereby limiting the potential limestone content of PLC. Using precipitated calcium carbonate from the disclosed processed will eliminate the need to co-grind the raw limestone with the clinker and allow for the optimization of limestone Portland Cement.

TABLE 2
Chemistry of CaCO₃ Precipitate and Dried and Filtered Treated FGDW

| | Concentration [mg/kg] | |
|---|---|---|
| Chemical | Precipitate | Dried Filtrate |
| Constituent | (CaCO₃ solid) | (NaCl solid) |
| Calcium | 220,000 | 4,300 |
| Chloride | 69,000 | 560,000 |
| Sodium | 65,000 | 290,000 |
| Magnesium | 12,000 | 14,000 |
| Boron | 6,700 | 6,600 |
| Bromide | 2,100 | 11,000 |
| Potassium | 1,600 | 7,700 |
| Selenium | 70 | 93 |
| Cadmium | 29 | ND |
| Barium | 13 | 1.6 |
| Arsenic | 5.3 | ND |
| Chromium | 3.6 | 6.30 |
| Lead | 2.3 | 1.9 |
| Mercury | 1.0 | 2.8 |
| Iron | ND | 54 |
| Aluminum | ND | 44 |
| Copper | ND | ND |

Note:
ND = non-detect

TABLE 3
Potential Commercial Applications for
CaCO₃ and NaCl Recovered from FGDW

| | CaCO₃ Precipitate | NaCl from Treated FGDW |
|---|---|---|
| Applications | Replace limestone | Leather tanning |
| | in Portland | brine |
| | Limestone Cement | |
| | Adhesives, Paint | Deicing salt |
| | and Coatings | |
| | Carpet backing | Extinguishing agent |
| | | in fire extinguishers. |
| | Pape | Chlorine source-for |
| | | chlorine used in PVC |
| | | and pesticide production. |

PLC has the potential to significantly improve concrete sustainability with lower carbon footprint and lower energy requirement, due to the decreased clinker content, and similar performance characteristics as compared to Ordinary Portland Cement (OPC). PLC can be used as a direct substitution for OPC in concrete mixtures. The use CaCO₃ precipitate recovered from FGDW using the disclosed process can further improve the value proposition. There are measurable physical and chemical benefits from using limestone in PLC that improve setting and strength characteristics, especially when supplementary cementitious materials (SCMs) like fly ash are also included in the concrete mixture.

The physical benefits result from the fineness of the PCC which provides better particle packing and higher paste density due to the enhanced overall cement particle size distribution. The smaller PCC particles in suspension between larger PC particles provide nucleation sites that improve hydration reaction efficiency. These nucleation sites are essentially intermediate sites for calcium silicate hydrate (CSH) growth.

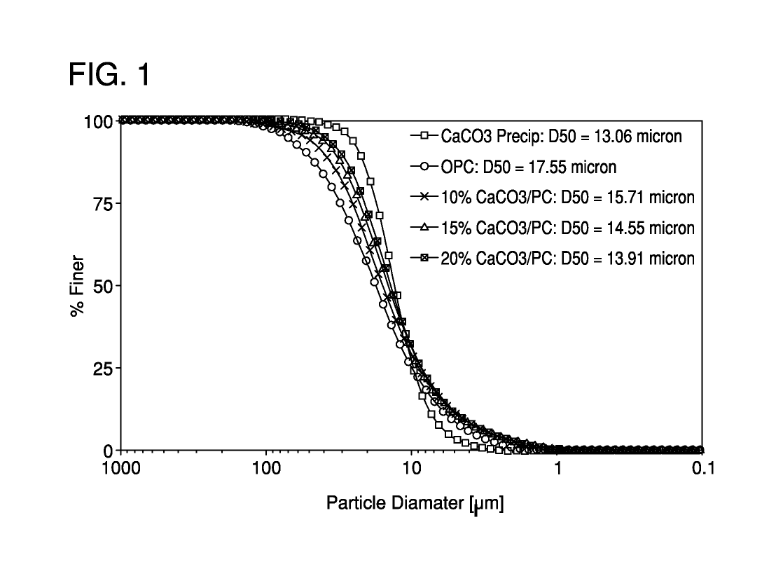

Precipitated CaCO₃ from FGDW provides the same physical benefits to concrete owing to the fine precipitate grade particle size. FIG. 1 shows particle size distribution for CaCO₃ precipitate from FGDW, Type I/II PC, as well as 10%, 15%, and 20% CaCO₃/PC blends. Increasing CaCO₃ content decreases the median particle size for the blended mixes. Due to the fineness of the precipitate grade CaCO₃, the median particle size for each blend decreases with increasing CaCO₃ content from 15.7 μm in the 10% blend, to 13.9 μm in the 20% blend.

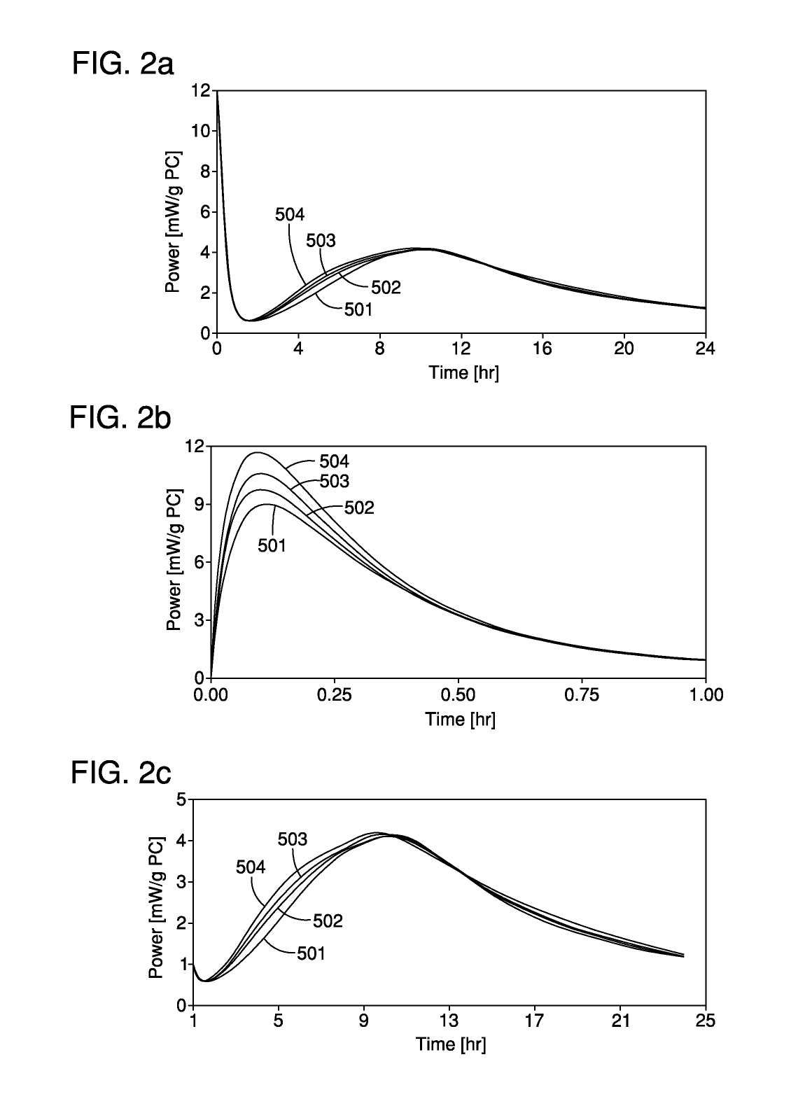

Chemically, limestone contributes calcium compounds that dissolve quickly and become available for hydration interaction. Calcium carbonate reacts with aluminate compounds to produce durable mono- and hemi-carboaluminate hydrate crystals. FIGS. 2a-2c below show the results of isothermal calorimetry analysis of hydrating Type I/II PC along with 10%, 15%, and 20% CaCO₃ precipitate and PC blends. The thermal power output from each sample is normalized by total mass of PC in the mix (W/g cem). The hydration reaction kinetics are similar for all the samples with an initial peak within the first hour of hydration and a second peak between hours 5 and 10. A synergistic interaction of CaCO₃ in each blend is demonstrated by the increase in thermal power per gram of PC as the CaCO₃ content increases and total PC mass decreases. The addition of CaCO₃ precipitate appears to accelerate early ages hydration as shown in FIG. 2B. By hour 13, however, the PC control sample shows the same thermal power output at the rest of the samples (FIG. 2C).

FIGS. 2a-c show thermal power per gram of PC generated during first 24 hours of hydration for PC and PC substituted with 10%, 15%, 20% CaCO₃ Precipitate. A: 0-24 hour, B: 0-1 hour, C: 1 hour-24 hour. In these figures, the reference numbers used are correlated to the particle samples as follows.

Reference Numeral 501=Control

Reference Numeral 502=10% PPC (CaCO₃)/PC

Reference Numeral 503=15% PPC(CaCO₃)/PC

Reference Numeral 504=20% PPC (CaCO₃)/PC

### Other Applications for CaCO₃ Precipitate

Other than in cement and concrete, there is a wide range of industrial and agricultural applications for powdered or precipitated CaCO₃. Such applications include: paints, plastics, rubber, ceramic and paper. CaCO₃ is also used as a filler material in carpet backing, which provides weight to the carpet and allows it to lay flat. In all these applications, CaCO₃ is used as chemically inert filler.

Applications for NaCl from Treated FGDW

### Leather Tanning

NaCl is extensively used in tanning leather, whereby animal hides are cured with salt so as to remove all the excess moisture and water from it. The salt draws water out of the leather hides and helps in protecting hides from bacterial growth.

### Deicing Salt

NaCl is spread on roadways to help reduce the accumulation of ice or to melt existing ice, it works by reducing the melting or freezing point of ice or freezing rain.

### Fire Extinguisher

NaCl is used to extinguish class D fires that are caused by the burning of metals like aluminum, magnesium potassium, etc. NaCl is spread on the fire creating a crust which smothers the fire.

### Chlorine for Further Chemical Synthesis:

NaCl is widely used for the production of chlorine. The process of electrolysis is carried out wherein electric current is passed through the solution of sodium chloride to prepare the element chlorine. This element is used extensively for making PVC and pesticides.

It is thus apparent then, that in certain embodiments, the present invention pertains to a cementitious mixture which comprises precipitate calcium carbonate (PCC) in combination with hydraulic cement. The PCC is obtained as precipitate product from reaction of flue gas desulfurization wastewater (FGDW) and sodium carbonate. In some instances, the hydraulic cement may comprise Portland Cement clinker. As is traditional in the industry, Portland Cement clinker is known to comprise alite, belite, tricalcium aluminate, and tetracalcium aluminate ferrite.

The weight ratio of PCC:hydraulic cement may be on the order of about 1-15 wt % PCC:combined Cement PCC (PLC).

In some embodiments, the hydraulic cement comprises a pozzolanic material. The pozzolan may comprise a natural pozzolan such as volcanic ash or diatomite or it may comprise an artificial pozzolan such as fly ash, calcined diatomite or calcined clay.

In certain embodiments, hardenable cementitious mixtures are made from:

| | Amounts |
|---|---|
| PCC | 1-35 wt % |
| Hydraulic Cement | 65-100 wt % |
| Water | 0.15- 1.5x (x = combined weight |
| | of PCC and binder) |

Aggregate such as sand, gravel, crushed stone, crushed rock, blast furnace slag, combustion slag, etc., may also be added to the cementitious mixtures, and accelerators or retardants can be added as needed. Generally, water added to the dry components (i.e., PCC, hydraulic cement, pozzolans, aggregate) should be on the order of about 0.15-1.5 times the weight of the dry components.

As is apparent from the above, the PCC serves as a limestone substitute or source in the cementitious compositions, providing CaCO₃. Preferably, the PCC has a particle size of about 1-100 μm and a median particle size of about 10-20 μm, preferably 10-15 μm.

As presently envisioned, the PCC can be supplied to concrete producers who will mix it with the appropriate hydraulic cement and optional aggregate, etc. Water will be added at the work location to provide a hardenable composition.

In other aspects, the PCC may be combined with fly ash and provided to the concrete producer as a dry mix that will be combined with hydraulic cement, optional aggregate, etc. Such dry mixes, as presently envisioned, may comprise about 1-99% PCC and 99-1 wt % fly ash. At the work location, the dry mix containing PCC, hydraulic cement, optional aggregate, etc., is mixed with water.

While the present invention has been described with respect to particular examples, it is apparent that numerous other forms and modifications of the invention will be obvious to those skilled in the art. The appended claims and this invention should be construed to cover all such obvious forms and modifications which are within the spirit and scope of the present invention.

1. Cementitious mixture comprising:
a) precipitate calcium carbonate (PCC) and
b) a hydraulic cement, said (PCC) being obtained as precipitate product from reaction of flue gas desulfurization wastewater (FGDW) and sodium carbonate.

2. Cementitious mixture as recited in claim 1 wherein said hydraulic cement comprises Portland Cement (PC) clinker.

3. Cementitious mixture as recited in claim 1 wherein said hydraulic cement comprises a pozzolanic material, wherein said PCC is present in an amount 1-35 wt % based on the weight of a) and b).

4. Cementitious mixture as recited in claim 3 wherein said pozzolanic material comprises fly ash.

5. Cementitious mixture as recited in claim 1 further comprising c) water, said water being present in an amount of c): 0.15-1.5x, wherein x is the combined weight of a) and b).

6. Cementitious mixture as recited in claim 1 wherein said a) PCC has a particle size ranging from about 1-100 μm.

7. Cementitious mixture as recited in claim 6 wherein said PCC has a median particle size of about 10-20 μm.

8. Cementitious mixture as recited in claim 7 wherein said PCC has a median particle size of about 10-15 μm.

9. Calcium carbonate adapted for use in a cementitious mixture, said calcium carbonate being a product of reaction of FGDW and soda ash.

10. Calcium carbonate as recited in claim 11 having a particle size of about 1-100 μm and a median particle size of about 10-20 μm.

11. Calcium carbonate as recited in claim 10 in combination with fly ash, said calcium carbonate being present in an amount of about 1-99 wt % based on the combined weight of said calcium carbonate and said fly ash, said fly ash being present in an amount of 99 wt %-1% wt based upon the combined weight of said calcium carbonate and fly ash.

12. Method of making a cementitious mixture comprising mixing precipitate calcium carbonate (PCC), and a hydraulic cement to form a mix, said PCC being obtained as precipitate product from reaction of flue gas desulfurization wastewater (FGDW) and sodium carbonate.

13. Method as recited in claim 12 wherein said hydraulic cement comprises Portland Cement clinker.

14. Method as recited in claim 13 comprising adding water to said mix.

15. Method as recited in claim 14 further comprising adding fly ash to said mix.

16. Method as recited in claim 14 further comprising adding aggregate to said mix.
